(19) United States
(12) Patent Application Publication
(10) Pub. No.: US 2008/0311433 A1
(43) Pub. Date: Dec. 18, 2008

(54) Fuel Cell System and Method for Determining Deterioration of Impurity Removal Member

(75) Inventor: Nobuo Fujita, Aichi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/659,098

(22) PCT Filed: Sep. 6, 2005
(86) PCT No.: PCT/JP05/16695

§ 371 Date: Feb. 1, 2007

(30) Foreign Application Priority Data
Sep. 7, 2004 (JP) 2004-259646

(51) Int. Cl. H01M 8/04

(52) U.S. Cl. 429/12; 73/865.8; 96/155

(57) ABSTRACT

A fuel cell system 1 has an impurity removal member 24 for removing impurities from a fluid discharged from a fuel cell 10, and the impurity removal member 24 is located in an exhaust passage 19 for the fluid discharged from the fuel cell 10 to flow through. The fuel cell system 1 includes: a physical quantity detection means 30 for detecting the physical quantities relating to the impurity removal member 24; and a deterioration determination means 40 for determining the degree of deterioration of the impurity removal member 24 based on the physical quantities detected by the physical quantity detection means 30.

### TECHNICAL FIELD

The present invention relates to a fuel cell system equipped with an impurity removal member for removing impurities contained in a fluid discharged from a fuel cell wherein the impurity removal member is located in an exhaust passage for the fluid discharged from the fuel cell to flow through. This invention also relates to a method for determining deterioration of the impurity removal member.

### BACKGROUND ART

There have been fuel cell systems equipped with an impurity removal member for removing impurities contained in a fluid discharged from a fuel cell wherein the impurity removal member is located in an exhaust passage for the fluid discharged from the fuel cell to flow through. In these fuel cell systems, not all supplied hydrogen is used for a cell reaction. Accordingly, the fuel cell system adopts a circulation system for effectively using the discharged and unreacted hydrogen by sending it back to the fuel cell again, and a gas-liquid separator is placed in the circulation system, and it removes moisture from a gas-liquid mixture fluid in which exhaust gas discharged from the fuel cell and water generated by the cell reaction of the fuel cell are mixed together and coexist.

Minute amounts of impurities dissolving from, for example, piping parts of the fuel cell or the system exist in the gas and water flowing through the circulation system. Also, impurities in the air drawn in from outside on the cathode side may enter a passage to the system, pass through an electrolyte membrane, and be mixed in the hydrogen circulation system. In particular, if metal ions exist in the impurities dissolving from, for example, piping parts of the fuel cell or the system, there is the possibility that the functions of the fuel cell itself may be degraded or the service life of the fuel cell may be shortened. In addition, the water generated in the fuel cell may become acidic. Accordingly, a method for preventing deterioration of the fuel cell due to, for example, the generated water and gas by placing an ion exchanger in the hydrogen circulation system has been adopted.

Recently, a solid polymer fuel cell system with an ion removal unit has been introduced, and the ion removal unit removes ions contained in water generated by the fuel cell and accompanied by an exhaust gas, and is placed on the side closer to a solid polymer fuel cell of at least one of exhaust pipes from which the water generated by the fuel cell is discharged. It is disclosed that in this solid polymer fuel cell system, fluoride ions are removed, using an ion exchange resin as a means for removing ions from the water. (See, for example, Patent Document 1).

Furthermore, a fuel cell system having a function predicting and determining the time to change an ion exchange processing device for removing ions from cooling water for the fuel cell or water generated by the fuel cell has also been introduced. (See, for example, Patent Documents 2 to 4).

[Patent Document 1] JP2002-313404 A

[Patent Document 2] JP5-315002 A

[Patent Document 3] JP2002-298892 A

[Patent Document 4] JP2003-346845 A

### DISCLOSURE OF THE INVENTION

The solid polymer fuel cell system described in Patent Document 1 is intended to separate the fluid (gas-liquid mixture fluid) into liquid and gas and then remove impurities from the liquid by having the separated liquid pass through the ion exchange resin. However, no consideration is given to predicting and determining when the ion exchange resin should be changed. Furthermore, no consideration is given to the idea of having the gas-liquid mixture fluid pass through this ion exchange resin to remove ions contained in the gas-liquid mixture fluid.

Regarding the gas-liquid mixture fluid (fluid before gas-liquid separation) discharged from the fuel cell, unlike a fluid in liquid state, its pressure may change considerably and its flow rate may also change. Accordingly, there would be a difference in the environment where the ion exchange processing device is used, between the case where the ion exchange processing device is placed in a cooling system or a piping system through which the water passes, and the case where the ion exchange processing device is placed in a piping system through which the gas-liquid mixture fluid passes. Consequently, deterioration conditions for the ion exchange processing device would also be different between those cases.

Although the fuel cell systems described in Patent Documents 2 to 4 predict and determine the time to change the ion exchange processing device for removing ions from the cooling water for or the water generated by the fuel cell, no consideration is given to the idea of predicting and determining the time to change the ion exchange processing device for removing ions from the gas-liquid mixture fluid.

The present invention aims to improve such conventional fuel cell systems. It is an object of the invention to provide a fuel cell system that can detect deterioration status of an impurity removal member capable of removing impurities contained in a gas-liquid mixture fluid, and one that can indicate when it is time to change the impurity removal member.

It is another object of the invention to provide a method for determining the deterioration status of the impurity removal member for removing impurities from the gas-liquid mixture fluid.

In order to achieve the objects described above, the invention provides a fuel cell system equipped with an impurity removal member for removing impurities from in a gas-liquid mixture fluid that is a mixture of an exhaust gas and a liquid discharged from a fuel cell wherein the impurity removal member is located in an exhaust passage for the gas-liquid mixture fluid to flow through, and the fuel cell system includes: a physical quantity detection means for detecting the physical quantities relating to the impurity removal member; and a deterioration determination means for determining the degree of deterioration of the impurity removal member based on the physical quantities detected by the physical quantity detection means.

Since the deterioration determination means in the fuel cell system having the above-described structure can determine the degree of deterioration of the impurity removal member based on the physical quantities relating to the impurity removal member as detected by the physical quantity detection means, the time to change the impurity removal member can be judged accurately. Accordingly, it is possible to use the impurity removal member until the impurity removal ability required for the impurity removal member becomes no longer effective, and it is also possible to prevent the use of the deteriorated impurity removal member without knowing that it has lost the necessary impurity removal ability.

The physical quantity detection means can include a shape change detection means for detecting a change in the shape of the impurity removal member. Because of this structure, it is possible to directly determine the deterioration status of the impurity removal member based on a change in the shape of the impurity removal member.

Furthermore, the physical quantity detection means can include a first fluid state quantity measurement means for measuring the state quantities of the fluid that has passed through the impurity removal member.

If the fuel cell system according to the invention has the first fluid state quantity measurement means, the fuel cell system can be configured so that the physical quantity detection means further includes a second fluid state quantity measurement means for measuring the state quantities of the fluid before passing through the impurity removal member, and the deterioration determination means includes a physical quantity comparison means for comparing the physical quantities detected by the first fluid state quantity measurement means with the physical quantities detected by the second fluid state quantity measurement means, thereby determining the degree of deterioration of the impurity removal member based on a value obtained by the physical quantity comparison means. This structure makes it possible to determine the deterioration status of the impurity removal member from a threshold value for a difference between the physical quantities detected by the first fluid state quantity measurement means and the physical quantities detected by the second fluid state quantity measurement means.

The state quantities of the fluid can be the state quantities of a liquid (generated water). The state quantities of the fluid can be, for example, the electric conductivity or pressure of the fluid.

Furthermore, the fuel cell system according to the invention can detect the physical quantities relating to the impurity removal member in the state where the liquid in the impurity removal member is reduced. Accordingly, the physical quantities relating to the impurity removal member can be detected in the state where disturbance components such as the generated water are excluded as much as possible. Therefore, it is possible to further enhance accuracy in determining deterioration of the impurity removal member.

Also, the fuel cell system according to the invention can be configured so that the physical quantity detection means includes: a gas state quantity detection means for detecting the state quantities of gas passing through the impurity removal member; and a liquid state quantity detection means for detecting the state quantities of liquid passing through the impurity removal member. This configuration makes it possible to determine the deterioration status of the impurity removal member by checking the state quantities of gas and liquid separately wherein the gas and the liquid are contained in the fluid. In other words, the deterioration status of the impurity removal member can be determined by reflecting the influence of deterioration unique to the gas and the liquid respectively. Therefore, it is possible to further enhance the accuracy in determining deterioration of the impurity removal member.

The gas state quantity detection means can calculate the state quantities of the gas based on the operational status of the fuel cell. The liquid state quantity detection means can calculate the state quantities of the liquid based on the operational status of the fuel cell.

The state quantities of the gas can be at least one of the flow rate, pressure, and temperature of the gas. The state quantities of the liquid can be at least one of the flow rate, pressure, and temperature of the liquid.

Moreover, the fuel cell system according to the invention can further include a gas-liquid separator for separating the fluid discharged from the fuel cell into gas and liquid, wherein the impurity removal member is placed in the gas-liquid separator.

Furthermore, the fuel cell system according to the invention can further include a gas-liquid separator for separating the fluid discharged from the fuel cell into gas and liquid, wherein the gas-liquid separator contains an electric conductivity measuring device for measuring the electric conductivity of the fluid. Also in this configuration, the impurity removal member can be placed in the gas-liquid separator.

The fuel cell system according to the invention can further include a notification means for indicating the result made by the deterioration determination means. Because of this configuration, it is possible to easily tell when the impurity removal member should be changed.

The invention also provides a method for determining deterioration of an impurity removal member for removing impurities from a gas-liquid mixture fluid that is a mixture of an exhaust gas and a liquid discharged from a fuel cell, wherein the impurity removal member is located in an exhaust passage for the gas-liquid mixture fluid to flow through, and the method includes: a detection step of detecting the physical quantities relating to the impurity removal member; and a determination step of determining the degree of deterioration of the impurity removal member based on the physical quantities detected by the detection step.

The detection step can include a step of detecting a change in the shape of the impurity removal member. The detection step can also include a first measurement step of measuring the state quantities of the fluid that has passed through the impurity removal member.

Moreover, the detection step can further include a second measurement step of measuring the state quantities of the fluid before passing through the impurity removal member, and the determination step can include a physical quantity comparison step of comparing the physical quantities detected by the first measurement step with the physical quantities detected by the second measurement step, thereby determining the degree of deterioration of the impurity removal member based on a value obtained by the physical quantity comparison step.

In the method for determining deterioration of the impurity removal member according to the invention, the state quantities of the fluid may be the state quantities, electric conductivity, or pressure of a liquid.

In the detection step, the physical quantities relating to the impurity removal member can be detected in the state where the liquid in the impurity removal member is reduced.

The detection step can include: a gas state quantity detection step of detecting the state quantities of gas passing through the impurity removal member; and a liquid state quantity detection step of detecting the state quantities of liquid passing through the impurity removal member.

The gas state quantity detection step and the liquid state quantity detection step can calculate the state quantities of the gas based on the operational status of the fuel cell.

Furthermore, in the method for determining deterioration of the impurity removal member according to the invention, the state quantities of the gas may be at least one of the flow rate, pressure, and temperature of the gas and the state quantities of the liquid may be at least one of the flow rate, pressure, and temperature of the liquid.

The method for determining deterioration of the impurity removal member according to the invention can further include a step of indicating the result made by the determination step.

Moreover, the method for determining deterioration of the impurity removal member according to the invention can be applied to a fuel cell system that further includes a gas-liquid separator for separating the fluid discharged from the fuel cell into gas and liquid, wherein the impurity removal member is placed in the gas-liquid separator.

Furthermore, the method for determining deterioration of the impurity removal member according to the invention can be applied to the fuel cell system that further includes a gas-liquid separator for separating the fluid discharged from the fuel cell into gas and liquid, wherein an electric conductivity measuring device for measuring the electric conductivity of the fluid is placed in the gas-liquid separator. In this case, the impurity removal member may be placed in the gas-liquid separator.

### BRIEF DESCRIPTION OF THE DRAWINGS

FIG. 1 is a schematic configuration diagram of a fuel cell system according to an embodiment of the present invention.

FIG. 2 is a schematic diagram of components of the fuel cell system in FIG. 1, i.e., a gas-liquid separator in which an impurity removal member is placed, and a physical quantity detection means and a deterioration determination means that are placed in the gas-liquid separator.

FIG. 3 shows the relationship between differential pressure of a fluid supplied to the gas-liquid separator shown in FIG. 2—the difference between the pressure of the fluid before passing through the impurity removal member and the pressure of the fluid after passing through the impurity removal member—and the fuel cell output or the fluid flow rate.

FIG. 4 is a flowchart illustrating the operation of the physical quantity detection means and the deterioration determination means shown in FIG. 2.

FIG. 5 is a schematic diagram of components of a fuel cell system according to another embodiment of the invention, i.e., a gas-liquid separator in which an impurity removal member is placed, and a physical quantity detection means and a deterioration determination means that are placed in the gas-liquid separator.

FIG. 6 is a schematic diagram of components of a fuel cell system according to another embodiment of the invention, i.e., a gas-liquid separator in which an impurity removal member is placed, and a physical quantity detection means and a deterioration determination means that are placed in the gas-liquid separator.

FIG. 7 shows the relationship between electric conductivity of the fluid and usable time for the impurity removal member.

FIG. 8 shows the relationship between the difference in electric conductivity of the fluid and usable time for the impurity removal member.

FIG. 9 is a schematic configuration diagram of a fuel cell system according to another embodiment of the invention.

FIG. 10 shows the relationship between an integrated value for the gas flow rate and an integrated value for the water quantity.

### BEST MODE FOR IMPLEMENTING THE INVENTION

The fuel cell system according to preferred embodiments of this invention will be described below with reference to the attached drawings. The embodiments described below are for the purpose of describing this invention, but the invention is not limited only to these embodiments. Accordingly, this invention can be utilized in various ways unless the utilizations depart from the gist of the invention.

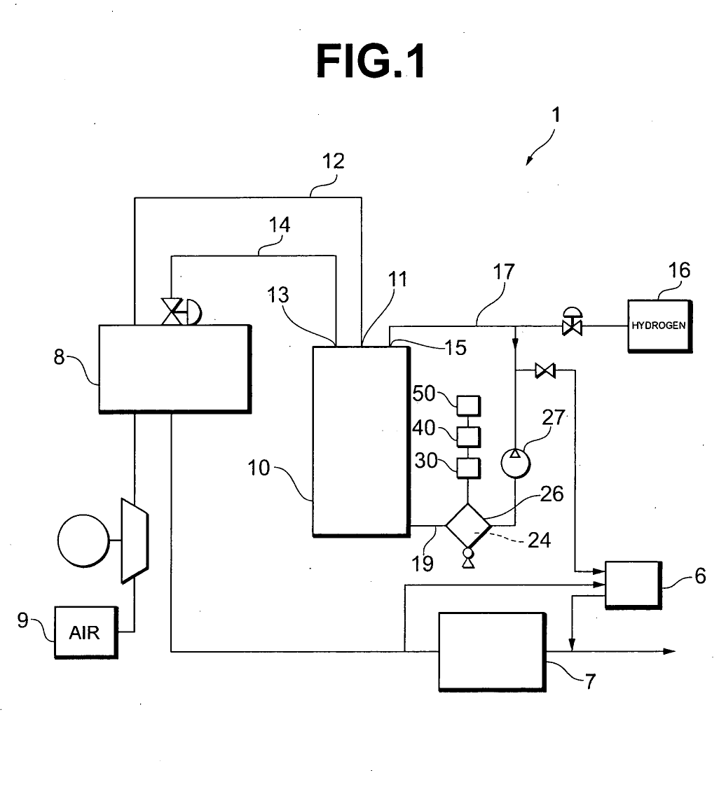

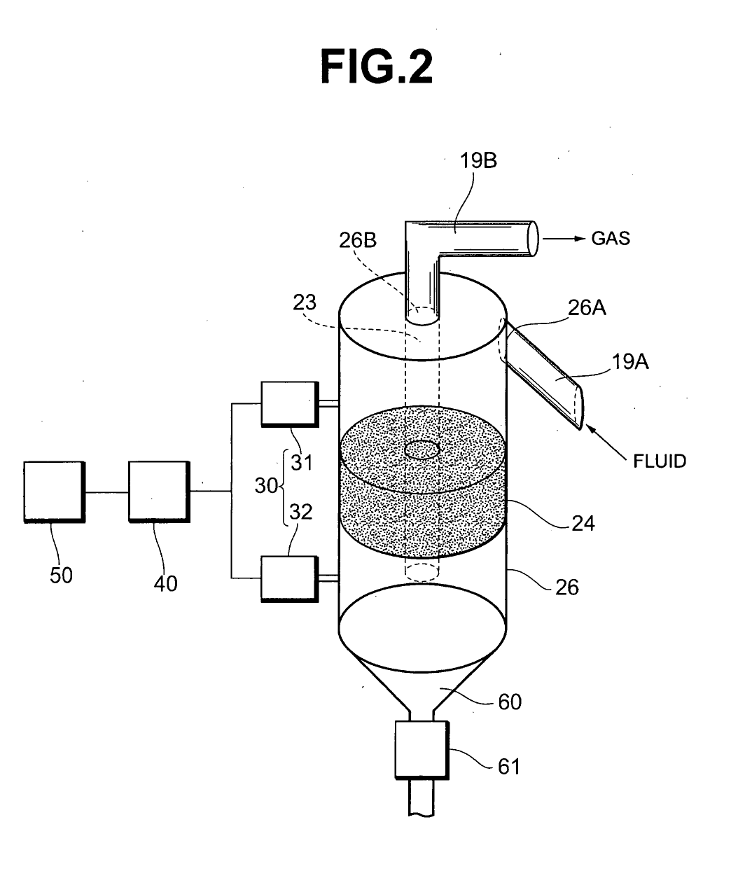

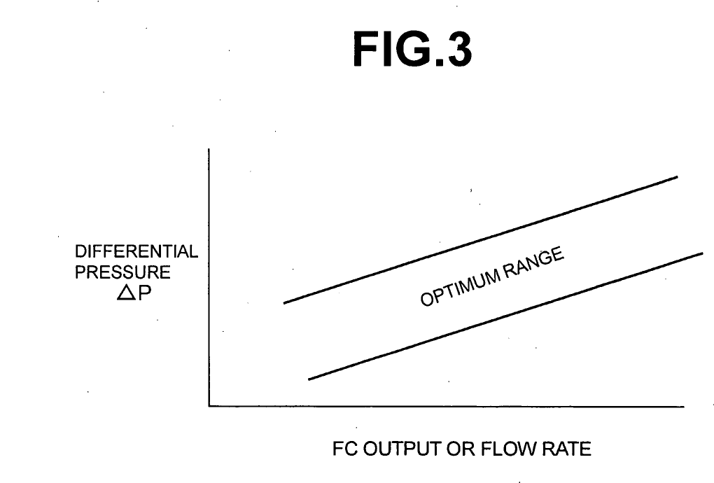

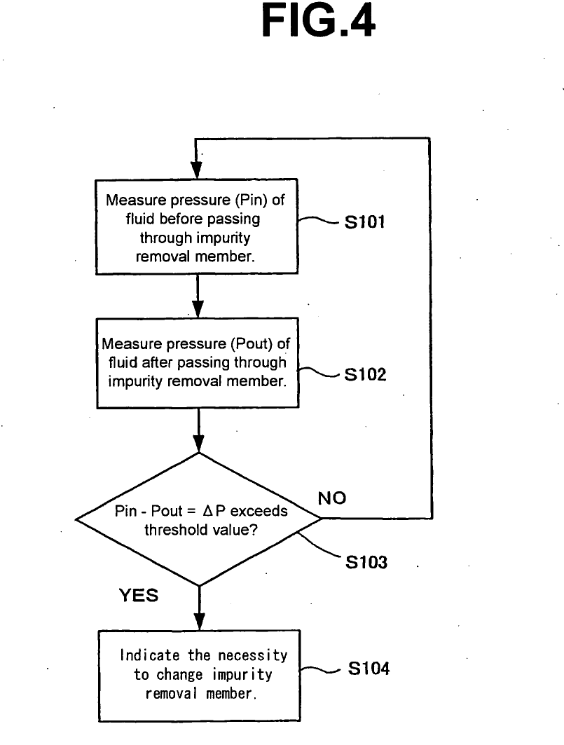

FIG. 1 is a schematic configuration diagram of a fuel cell system according to an embodiment of the present invention. FIG. 2 is a schematic diagram of components of the fuel cell system in FIG. 1, i.e., a gas-liquid separator in which an impurity removal member is placed, and a physical quantity detection means and a deterioration determination means that are placed in the gas-liquid separator. FIG. 3 shows the relationship between differential pressure of a fluid supplied to the gas-liquid separator shown in FIG. 2—the difference between the pressure of the fluid before passing through the impurity removal member and the pressure of the fluid after passing through the impurity removal member—and the fuel cell output or the fluid flow rate. FIG. 4 is a flowchart illustrating the operation sequence of the physical quantity detection means and the deterioration determination means shown in FIG. 2.

A fuel cell 10 of a fuel cell system 1 shown in FIG. 1 is configured in such a way that it contains a stack made of a plurality of cells, each of which is constructed by laying an MEA and a separator, one over the other; wherein the separator forms a passage for supplying a fuel gas (hydrogen) to a fuel electrode (or anode) of the MEA, and an oxidizing gas (oxygen [usually the air]) to an oxidizer electrode (or cathode).

An air supply port 11 of this fuel cell 10 is connected via an air supply passage 12 to an air supply source 9 for supplying air as an oxidizing gas, while an air exhaust port 13 is connected to an air exhaust passage 14 for exhausting the air and water (discharge fluid) discharged from the fuel cell 10. A humidification module 8 is placed in the air supply passage 12 and the air exhaust passage 14, and the discharge fluid that has passed through this humidification module 8 will flow through a muffler 7 and then be discharged from the fuel cell system 1. Also, part of the discharge fluid is supplied to a hydrogen diluter 6 and will be discharged after it is used for dilution of hydrogen.

On the other hand, a hydrogen supply port 15 of the fuel cell 10 is connected via a hydrogen supply passage 17 to a hydrogen supply source 16 such as a hydrogen cylinder, and a hydrogen exhaust port is connected to a hydrogen exhaust passage 19. A gas-liquid separator 26 is placed somewhere inside this hydrogen exhaust passage 19. Specifically as shown in FIG. 2, a fluid inlet connector 19A of the hydrogen exhaust passage 19 is connected to a fluid inlet 26A of the gas-liquid separator 26 so as to allow the fluid to flow into the fluid inlet 26A, and a fluid outlet connector 19B of the hydrogen exhaust passage 19 is connected to a fluid outlet 26B of the gas-liquid separator 26 so as to allow the fluid to flow out of the fluid outlet 19B.

Moreover, an impurity removal member 24 is placed in the gas-liquid separator 26. Furthermore, a gas passage 23 connected to the fluid outlet 26B so as to allow the gas to flow out of the fluid outlet 26B is placed in the center area of the gas-liquid separator 26 so that it passes through the center area of the impurity removal member 24 and extends along the vertical direction in FIG. 2.

In this embodiment, an ion exchange resin is used as the impurity removal member 24. Also, a cyclone gas-liquid separator for separating the fluid (gas-liquid mixture) into gas and liquid by swirling the fluid is used as the gas-liquid separator 26.

The gas-liquid separator 26 is connected to: a physical quantity detection means 30 for detecting the physical quantities of the impurity removal member 24; and a deterioration determination means 40 for determining the degree of deterioration of the impurity removal member 24 based on the physical quantities detected by the physical quantity detection means 30.

Specifically as shown in FIG. 2, the physical quantity detection means 30 includes: an inlet pressure measuring device 31 for measuring the pressure (Pin) of the fluid supplied to the gas-liquid separator 26 before passing through the impurity removal member 24; and an outlet pressure measuring device 32 for measuring the pressure (Pout) of the fluid after passing through the impurity removal member 24. In this embodiment, the pressure (Pin) and the pressure (Pout) are the physical quantities relating to the impurity removal member 24.

The inlet pressure measuring device 31 and the outlet pressure measuring device 32 are connected to a deterioration determination means 40 for calculating the difference (ΔP=Pin−Pout) between the pressures (Pin) and (Pout) measured by the inlet pressure measuring device 31 and the outlet pressure measuring device 32 and checking whether the calculated value exceeds a predetermined threshold value or not.

As shown in FIG. 3, a proportional relationship is established between the differential pressure (ΔP=Pin−Pout) and the output of the fuel cell 10 or the flow rate of the fluid discharged from the fuel cell 10. Accordingly, how much the impurity removal member 24 is capable of removing impurities at the present moment can be found by calculating the differential pressure (ΔP=Pin−Pout) and checking whether the differential pressure is within the optimum range or not (i.e., whether the differential pressure exceeds the threshold value or not), and the time to change the impurity removal member 24 can be judged by checking if the impurity removal ability of the impurity removal member 24 is still effective or not.

Incidentally, the differential pressure (ΔP) relates to the flow resistance of the fluid. This flow resistance of the fluid is determined by, for example, the amount of impurities trapped by the impurity removal member 24, the expansion or contraction status of the impurity removal member 24 as caused by the influence of the impurities trapped by the impurity removal member 24, and the density of the impurities contained in the fluid.

The deterioration determination means 40 is connected to a notification means 50 for indicating, based on the determination result made by the deterioration determination means 40, whether the impurity removal member 24 should be changed or not. Various forms of this notification means 50 are possible, such as alarms (alarm sounds) or a message on an appropriate display unit, indicating that it is time to change the impurity removal member 24.

An operation sequence of the physical quantity detection means 30, the deterioration determination means 40, and the notification means 50 is described below. As shown in FIG. 4, the inlet pressure measuring device 31 measures the pressure (Pin) of the fluid, which is supplied from the hydrogen exhaust passage 19 to the gas-liquid separator 26, before passing through the impurity removal member 24 (step S101). This measured value is output to the deterioration determination means 40. Next, the outlet pressure measuring device 32 measures the pressure (Pout) of the fluid after passing through the impurity removal member 24 (step S102). This measured value is output to the deterioration determination means 40.

Subsequently, the deterioration determination means 40 calculates a difference (ΔP=Pin−Pout) between the pressures received from the inlet pressure measuring device 31 and the outlet pressure measuring device 32, and checks if the differential pressure (ΔP) exceeds a predetermined threshold value or not (step S103). If the differential pressure (ΔP) obtained in step S103 exceeds the predetermined threshold value (step S103: YES), the deterioration determination means 40 outputs a signal of that result to the notification means 50, and the notification means 50 indicates that it is time to change the impurity removal member 24. On the other hand, if the differential pressure (ΔP) obtained in step S103 does not exceed the predetermined threshold value step S103 (step S103: NO), steps S101 to S103 are repeated.

After the fluid supplied to the gas-liquid separator 26 is separated into gas (hydrogen) and liquid (water) and the impurity removal member 24 removes impurities from the fluid, the fluid is discharged from the gas-liquid separator 26 and then resupplied from the hydrogen supply passage 17 to the fuel cell 10 and used for the cell reaction. Also, part of the gas (hydrogen) discharged from the gas-liquid separator 26 is supplied to the hydrogen diluter 6 as necessary. On the other hand, the liquid separated from the gas-liquid fluid and from which impurities are removed is collected at an exhaust port 60 located below the gas-liquid separator 26 and is discharged by opening an electromagnetic valve 61. Reference numeral 27 indicates a hydrogen pump.

This embodiment described the case where the inlet pressure measuring device 31 for measuring the state quantity (pressure Pin) of the fluid before passing through the impurity removal member 24, and the outlet pressure measuring device 32 for measuring the state quantity (pressure Pout) of the fluid after passing through the impurity removal member 24 are provided and the degree of deterioration of the impurity removal member 24 is determined based on the differential pressure (ΔP) between the pressures obtained above. However, the deterioration determination method is not limited to the above example, and the deterioration determination means 40 may judge the degree of deterioration of the impurity removal member 24 based on only the pressure (Pout) of the fluid after passing through the impurity removal member 24.

Also, in this embodiment, the pressure may be measured in the state where the liquid adhered to the impurity removal member 24 is reduced. In this case, the physical quantities relating to the impurity removal member 24 can be detected in the state where disturbance components such as the generated water are excluded as much as possible. Therefore, it is possible to further enhance the accuracy in determining deterioration of the impurity removal member 24.

Furthermore, this embodiment described the case where the physical quantity detection means 30 for detecting the pressure of the fluid is provided. However, the configuration of the quantity detection means 30 is not limited to the above example, and the physical quantity detection means 30 may have other configurations as long as it can detect the physical quantities of the impurity removal member 24.

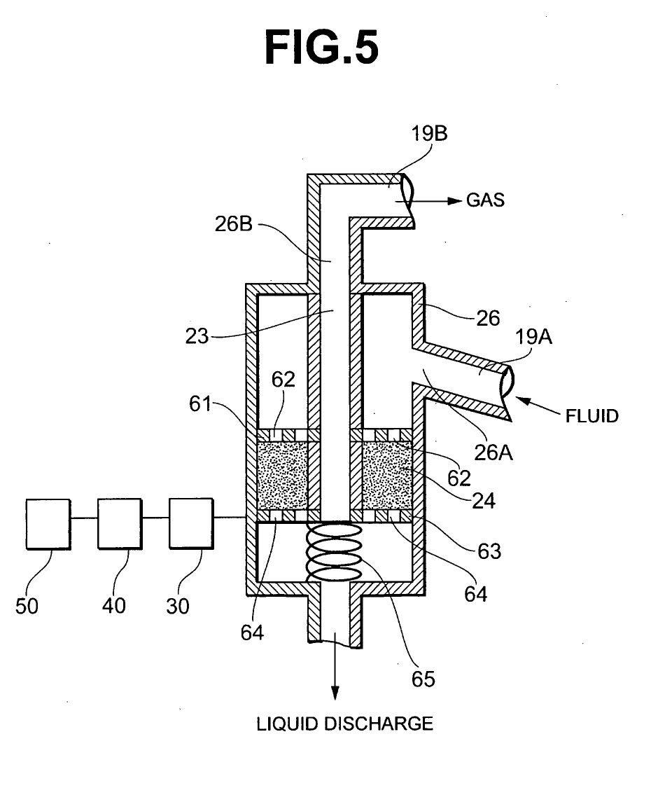

According to another embodiment of the invention as shown in FIG. 5, the gas-liquid separator 26 can include: a support plate 161 that is located upstream from the impurity removal member 24 (on the top surface of the impurity removal member 24 in FIG. 5), whose outside surface is fixed to the inside wall of the impurity removal member 24, and in which a plurality of through-holes for supplying the fluid to the impurity removal member 24 are formed; a movable plate 63 that is located downstream of the impurity removal member 24 (under the bottom surface of the impurity removal member 24 in FIG. 5) and can slide up and down with its outside surface in contact with the inside wall of the gas-liquid separator 26, and in which a plurality of through-holes 64 capable of discharging the fluid that has passed through the impurity removal member 24 are formed; a spring member 65 that is located below the movable plate 63 in the gas-liquid separator 26 and applies force to the movable plate 63 toward the support plate 161; and a position detecting device (position sensor) serving as the physical quantity detection means 30, that detects the position of the movable plate 63 and is located in the movable plate 63.

In the case of the configuration described above, the physical quantity detection means 30 detects the movement distance of the movable plate 63 (the physical quantities relating to the impurity removal member 24) in association with expansion or contraction of the impurity removal member 24 caused by the influence of the impurities trapped by the impurity removal member 24, and outputs this detected value to the deterioration determination means 40. The deterioration determination means 40 checks whether this detected value exceeds a predetermined threshold value or not. If the detected value exceeds the predetermined threshold value, the deterioration determination means 40 outputs a signal of that result to the notification means 50, which then indicates that it is time to change the impurity removal member 24. On the other hand, if the detected value does not exceed the threshold value, the step of detecting the movement distance of the movable plate 63 and checking whether the detected value exceeds the threshold value or not is repeated.

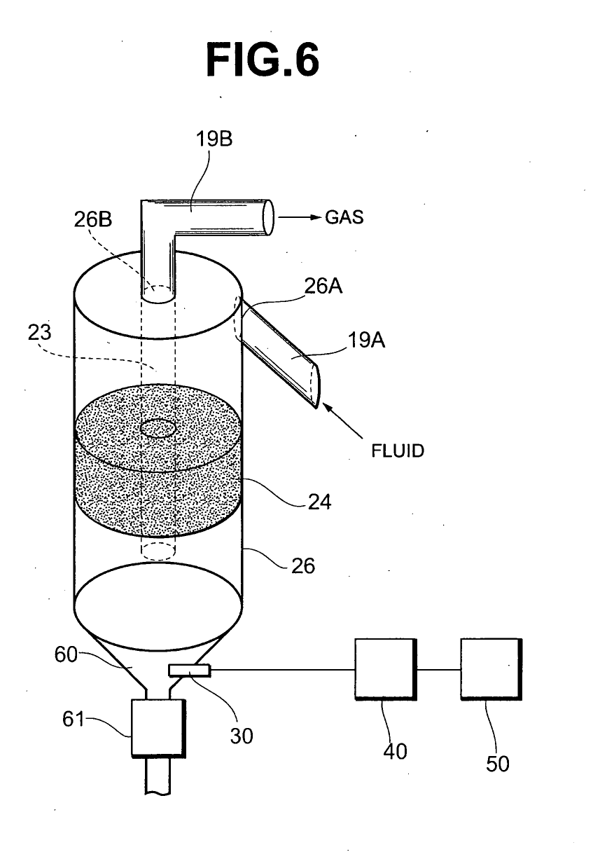

According to another embodiment of the invention as shown in FIG. 6, an electric conductivity measuring device may be used as the physical quantity detection means 30 instead of the inlet pressure measuring device 31 and the outlet pressure measuring device 32. In this embodiment shown in FIG. 6, the electric conductivity measuring device is placed at the discharge port 60 located below the gas-liquid separator 26 so that it can measure the electric conductivity of the liquid (generated water) separated from the gas-liquid fluid by the gas-liquid separator 26.

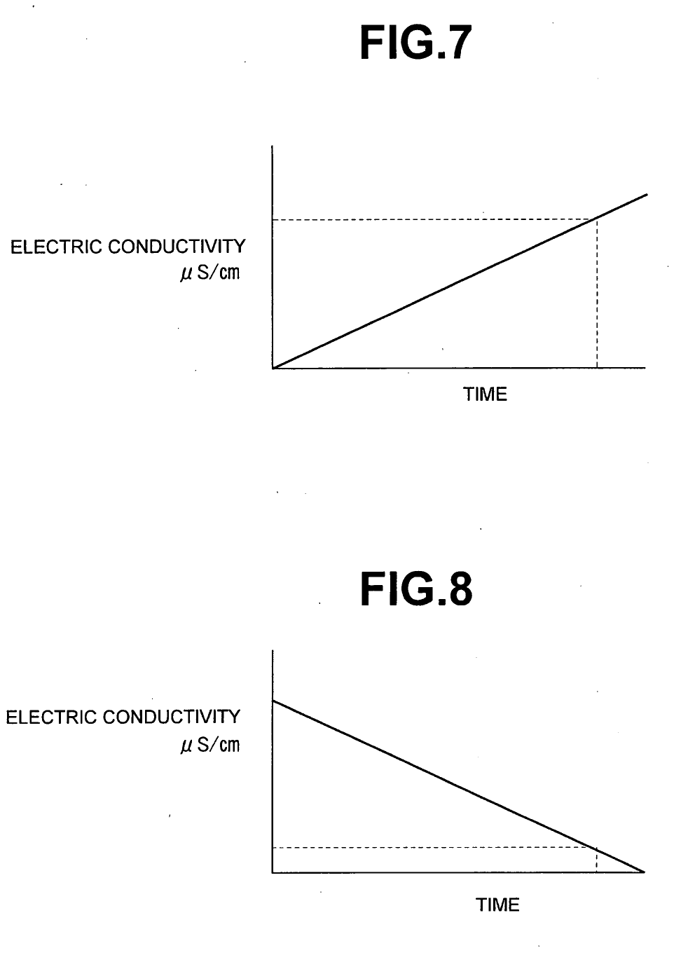

As shown in FIG. 7, a proportional relationship is established between the electric conductivity of the liquid received by the discharge port 60 and the usable time of the impurity removal member 24 (the period of time during which the impurity removal member 24 retains the required impurity removal ability). Accordingly, by measuring the electric conductivity of the liquid and outputting the measured value (detected value) to the deterioration determination means 40, the deterioration determination means 40 can check whether the impurity removal member 24 has the required impurity removal ability or not. Specifically speaking, if the electric conductivity measured by the electric conductivity measuring device (the physical quantity detection means 30) exceeds a predetermined threshold value, the deterioration determination means 40 outputs a signal of that result to the notification means 50, which then indicates that it is time to change the impurity removal member 24. On the other hand, if this electric conductivity does not exceed the threshold, the measurement of the electric conductivity and the comparison of the measured value with the threshold value are repeated.

The embodiment shown in FIG. 6 described the case where the electric conductivity measuring device (the physical quantity detection means 30) is placed at the discharge port 60. However, the configuration of the invention is not limited to the above example, and the electric conductivity measuring device may be located at a different position as long as the electric conductivity of the fluid (liquid, gas, or gas-liquid mixture) that has passed through the impurity removal member 24 can be measured at that position.

In addition to the electric conductivity measuring device (the physical quantity detection means 30) located at the discharge port 60, the electric conductivity measuring device may be also placed at the hydrogen exhaust passage 19 located upstream from the gas-liquid separator 26, in order to measure the electric conductivity of the liquid flowing there. Consequently, a difference between the electric conductivity of the liquid before passing through the impurity removal member 24 and the electric conductivity of the liquid after passing through the impurity removal member 24 may be calculated, using both the electric conductivity measuring devices.

As shown in FIG. 8, the inverse proportional relationship is established between an electric conductivity difference—the difference between the electric conductivity of the liquid before passing through the impurity removal member 24 and the electric conductivity of the liquid after passing through the impurity removal member 24—and the usable time of the impurity removal member 24 (the period of time in which the impurity removal member 24 retains the required impurity removal ability). Accordingly, by calculating the electric conductivity difference and outputting it to the deterioration determination means 40, the deterioration determination means 40 can check whether the impurity removal member 24 has the necessary impurity removal ability or not. If the electric conductivity difference exceeds a predetermined threshold value, the notification means 50 indicates in the same manner as described above that it is time to change the impurity removal member 24.

Incidentally, in a vehicle or similar that uses a fuel cell, water generated by the fuel cell is guided via an exhaust hose to the outside at the time of electric power generation by the fuel cell. Accordingly, it is possible to provide electric isolation via the generated water between the fuel cell and the vehicle.

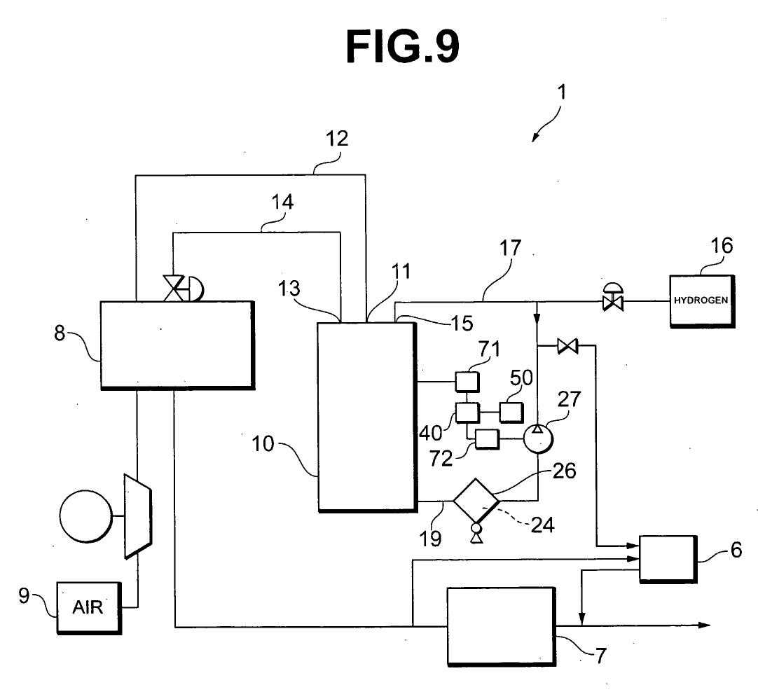

Furthermore, a fuel cell system according to another embodiment of the invention may be configured as shown in FIG. 9 so that the fuel cell 10 is connected to a generated electric current measuring device 71 for measuring the electric current generated by the fuel cell 10, the hydrogen pump 27 is connected to a pump operation status measuring device 72 for measuring the operation status (such as the number of revolutions, suction pressure, and discharge pressure) of the hydrogen pump 27, the generated electric current measuring device 71 and the pump operating status measuring device 72 are connected to the deterioration determination means 40, and the deterioration determination means 40 is connected to the notification means 50.

Here, the proportional relationship is established between the quantity of water (L) discharged from the fuel cell 10 and the electric energy generated by the fuel cell 10. Specifically speaking, the water quantity (L) is expressed as follows:

L=C×I

“C” is a constant of the fuel cell, and “I” is an electric current value. This water quantity (L) is used to calculate an integrated value for the water quantity.

On the other hand, the flow rate of the gas (Q) passing through the impurity removal member 24 is expressed as follows:

Q=hydrogen gas discharge quantity×number of pump revolutions×f(Ps)×f(t)×η

“Ps” is a pump suction pressure, “t” is a temperature, and “η” is f(Pd).

“Pd” is a pump discharge pressure. This gas flow rate (Q) is used to calculate an integrated value for the flow rate of the gas passing through the impurity removal member 24.

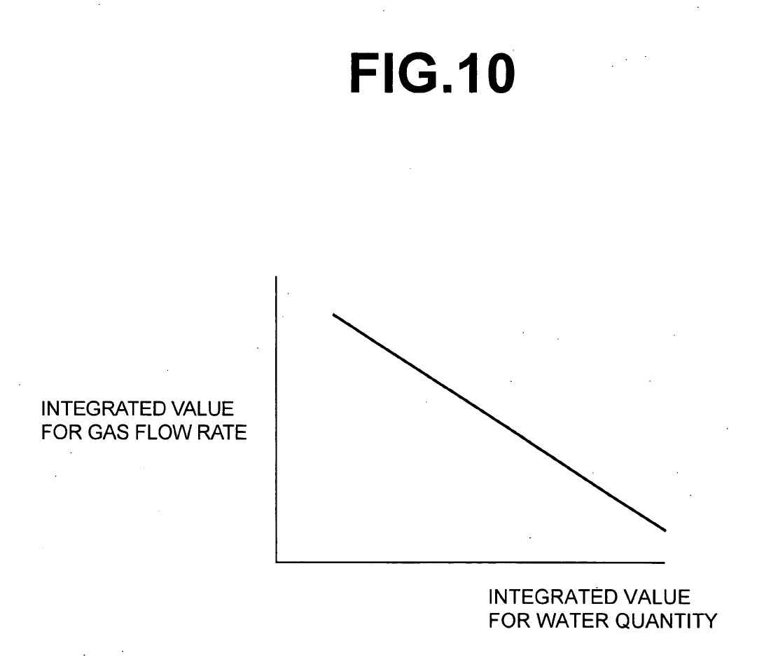

As shown in FIG. 10, the inverse proportional relationship is established between the integrated value for the water quantity and the integrated value for the gas flow rate. Accordingly, by calculating the integrated value for the water quantity and the integrated value for the gas flow rate and outputting these values to the deterioration determination means 40, the deterioration determination means 40 can check whether the impurity removal member 24 has the necessary impurity removal ability or not. If the relationship between the integrated values obtained above exceeds a predetermined threshold value, the notification means 50 indicates that it is time to change the impurity removal member 24.

The embodiment shown in FIG. 9 described the case where the physical quantity detection means according to the invention is composed of the generated electric current measuring device 71 and the pump operation status measuring device 72. Since the water quantity can be calculated based on the generated electric current measured by the generated electric current measuring device 71, it is possible to calculate the state quantity (flow rate) of the liquid passing through the impurity removal member 24. In other words, the generated electric current measuring device 71 functions as the liquid state quantity detection means for detecting the state quantity (flow rate) of the liquid passing through the impurity removal member 24 based on the operation status (generated electric energy) of the fuel cell 10.

Also, the state quantity (flow rate) of the gas passing through the impurity removal member 24 can be calculated based on the pump operation status measured by the pump operating status measuring device 72. In other words, the pump operating status measuring device 72 serves as the gas state quantity detection means for detecting the state quantity (flow rate) of the gas flowing through the impurity removal member 24 based on the pump operating status determined by the operating status of the fuel cell 10.

Incidentally, the state quantities of the gas may be at least one of the flow rate, pressure, and temperature of the gas. The state quantities of the liquid may be at least one of the flow rate, pressure, and temperature of the liquid.

Also, various types of physical quantities such as pH of the fluid, the fluid flow rate, the fluid temperature, and the operation status of the fuel cell, as well as those described above are possible as the physical quantities relating to the impurity removal member 24. There is no particular limitation on the type of physical quantities.

The aforementioned embodiments describe the case where the impurity removal member 24 is placed in the gas-liquid separator 26. However, the position of the impurity removal member 24 is not limited to this example, and the impurity removal member 24 may be located at a desired position in the hydrogen exhaust passage 19.

Moreover, the aforementioned embodiments describe the case where the impurity removal member 24 is placed in the hydrogen circulation system. However, the position of the impurity removal member 24 is not limited to this example, and the impurity removal member 24 according to the invention may be placed in an oxidizing gas (air) supply system or other piping systems.

Furthermore, the aforementioned embodiments described the case where the ion exchange resin is used as the impurity removal member 24. However, the material for the impurity removal member is not limited to this example, and the impurity removal member 24 according to the invention may be made of other materials as long as it can remove impurities from the fluid.

Also, the aforementioned embodiments described the case where the cyclone gas-liquid separator is used as the gas-liquid separator 26. However, the type of gas-liquid separator is not limited to this example, and it should be understood that a gas-liquid separator for separating the gas-liquid fluid into gas and liquid by other methods may be used.

### INDUSTRIAL APPLICABILITY

The fuel cell system according to the invention includes: a physical quantity detection means for detecting the physical quantities relating to the impurity removal member; and a deterioration determination means for determining the degree of deterioration of the impurity removal member based on the physical quantities detected by the physical quantity detection means. Accordingly, the degree of deterioration of the impurity removal member can be detected based on the physical quantities relating to the impurity removal member as detected by the physical quantity detection means. Therefore, it is possible to find out when the impurity removal member should be changed, and to use the impurity removal member until the impurity removal member loses its required impurity removal ability. It is also possible to prevent the use of the deteriorated impurity removal member. As a result, the reliability of the fuel cell system can be enhanced and running costs can be reduced.

Also, the method for determining deterioration of the impurity removal member according to the invention includes: a detection step of detecting the physical quantities relating to the impurity removal member; and a determination step of determining the degree of deterioration of the impurity removal member based on the physical quantities detected by the detection step. Accordingly, it is possible to easily determine the deterioration status of the impurity removal member.

1. A fuel cell system equipped with an impurity removal member for removing impurities from in a gas-liquid mixture fluid that is a mixture of an exhaust gas and a liquid discharged from a fuel cell, the impurity removal member being located in an exhaust passage for the gas-liquid mixture fluid to flow through,
the fuel cell system comprising:
a physical quantity detection means for detecting the physical quantities relating to the impurity removal member; and
a deterioration determination means for determining the degree of deterioration of the impurity removal member based on the physical quantities detected by the physical quantity detection means.

2. The fuel cell system according to claim 1, wherein the physical quantity detection means includes a shape change detection means for detecting a change in the shape of the impurity removal member.

3. The fuel cell system according to claim 1, wherein the physical quantity detection means includes a first fluid state quantity measurement means for measuring the state quantities of the fluid that has passed through the impurity removal member.

4. The fuel cell system according to claim 3, wherein the physical quantity detection means further includes a second fluid state quantity measurement means for measuring the state quantities of the fluid before passing through the impurity removal member, and
wherein the deterioration determination means includes a physical quantity comparison means for comparing the physical quantities detected by the first fluid state quantity measurement means with the physical quantities detected by the second fluid state quantity measurement means, thereby determining the degree of deterioration of the impurity removal member based on a value obtained by the physical quantity comparison means.

5. The fuel cell system according to claim 3, wherein the state quantities of the fluid are the state quantities of a liquid.

6. The fuel cell system according to claim 3, wherein the state quantities of the fluid are the electric conductivity of the fluid.

7. The fuel cell system according to claim 3, wherein the state quantities of the fluid are the pressure of the fluid.

8. The fuel cell system according to claim 1, wherein the physical quantities relating to the impurity removal member are detected in the state where the liquid in the impurity removal member is reduced.

9. The fuel cell system according to claim 1, wherein the physical quantity detection means includes: a gas state quantity detection means for detecting the state quantities of gas passing through the impurity removal member; and a liquid state quantity detection means for detecting the state quantities of liquid passing through the impurity removal member.

10. The fuel cell system according to claim 9, wherein the gas state quantity detection means calculates the state quantities of the gas based on the operational status of the fuel cell.

11. The fuel cell system according to claim 9, wherein the liquid state quantity detection means calculates the state quantities of the liquid based on the operational status of the fuel cell.

12. The fuel cell system according to claim 9, wherein the state quantities of the gas is at least one of the flow rate, pressure, and temperature of the gas.

13. The fuel cell system according to claim 9, wherein the state quantities of the liquid is at least one of the flow rate, pressure, and temperature of the liquid.

14. The fuel cell system according to claim 1, further comprising a gas-liquid separator for separating the fluid discharged from the fuel cell into gas and liquid, wherein the impurity removal member is placed in the gas-liquid separator.

15. The fuel cell system according to claim 6, further comprising a gas-liquid separator for separating the fluid discharged from the fuel cell into gas and liquid, wherein the gas-liquid separator contains an electric conductivity measuring device for measuring the electric conductivity of the fluid.

16. The fuel cell system according to claim 15, wherein the impurity removal member is placed in the gas-liquid separator.

17. The fuel cell system according to claim 1, further comprising a notification means for indicating the result made by the deterioration determination means.

18. A method for determining deterioration of an impurity removal member for removing impurities from a gas-liquid mixture fluid that is a mixture of an exhaust gas and a liquid discharged from a fuel cell, the impurity removal member being located in an exhaust passage for the gas-liquid mixture fluid to flow through, the method comprising:
a detection step of detecting the physical quantities relating to the impurity removal member; and
a determination step of determining the degree of deterioration of the impurity removal member based on the physical quantities detected by the detection step.

19. The method for determining deterioration of the impurity removal member according to claim 18, wherein the detection step includes a step of detecting a change in the shape of the impurity removal member.

20. The method for determining deterioration of the impurity removal member according to claim 18, wherein the detection step includes a first measurement step of measuring the state quantities of the fluid that has passed through the impurity removal member.

21. The method for determining deterioration of the impurity removal member according to claim 20, wherein the detection step further includes a second measurement step of measuring the state quantities of the fluid before passing through the impurity removal member, and
wherein the determination step includes a physical quantity comparison step of comparing the physical quantities detected by the first measurement step with the physical quantities detected by the second measurement step, thereby determining the degree of deterioration of the impurity removal member based on a value obtained by the physical quantity comparison step.

22. The method for determining deterioration of the impurity removal member according to claim 20, wherein the state quantities of the fluid are the state quantities of a liquid.

23. The method for determining deterioration of the impurity removal member according to claim 20, wherein the state quantities of the fluid are the electric conductivity or pressure of the fluid.

24. The method for determining deterioration of the impurity removal member according to claim 18, wherein the physical quantities relating to the impurity removal member are detected in the state where the liquid in the impurity removal member is reduced.

25. The method for determining deterioration of the impurity removal member according to claim 18, wherein the detection step includes: a gas state quantity detection step of detecting the state quantities of gas passing through the impurity removal member; and a liquid state quantity detection step of detecting the state quantities of liquid passing through the impurity removal member.

26. The method for determining deterioration of the impurity removal member according to claim 25, wherein the gas state quantity detection step calculates the state quantities of the gas based on the operational status of the fuel cell.

27. The method for determining deterioration of the impurity removal member according to claim 25, wherein the liquid state quantity detection step calculates the state quantities of the liquid based on the operational status of the fuel cell.

28. The method for determining deterioration of the impurity removal member according to claim 25, wherein the state quantities of the gas are at least one of the flow rate, pressure, and temperature of the gas.

29. The method for determining deterioration of the impurity removal member according to claim 25, wherein the state quantities of the liquid are at least one of the flow rate, pressure, and temperature of the liquid.

30. The method for determining deterioration of the impurity removal member according to claim 18, further comprising a step of indicating the result made by the determination step.
